(19) United States
(12) Patent Application Publication
(10) Pub. No.: US 2005/0181734 A1
(43) Pub. Date: Aug. 18, 2005

(54) Automatic connection of a mobile device to a wireless network

(75) Inventors: Daryl D. Coutts, Edmonton (CA); James T. Deith, Courtenay (CA)

Correspondence Address: THOMPSON LAMBERT;SUITE 703D, CRYSTAL PARK TWO, 2121 CRYSTAL DRIVE, ARLINGTON, VA, 22202, US

(73) Assignee: Knightsbridge Wireless Inc., Edmonton (CA)

(21) Appl. No.: 11/103,620

(22) Filed: Apr. 12, 2005

Related U.S. Application Data
(63) Continuation-in-part of application No. 11/038,249, filed on Jan. 21, 2005.

(51) Int. Cl. H04B 17/00

(52) U.S. Cl. 455/67.16

(57) ABSTRACT

A novel method for automatically connecting a mobile device to a wireless network is presented. The goal of the automatic connection of a mobile device to a wireless network is to provide a rapid wireless network connection for a mobile device when it comes into range of a desired network while reducing rf emissions when the mobile device is not in range of a desired wireless network. The method focuses on adjusting the time between network connection attempts when the mobile device is not connected to a network. The method increases the time between network connection attempts when the mobile device is stationary and decreases the time between network connection attempts when the mobile device is moving.

### CROSS-REFERENCE TO RELATED APPLICATIONS

This application is a continuation-in-part of U.S. application Ser. No. 11/038,249 filed Jan. 21, 2005, pending.

### BACKGROUND OF THE INVENTION

This invention relates to automatic connection of mobile devices to wireless networks.

With the proliferation of wifi networks, it is possible for wireless mobile devices such as PDAs, to function not only as traditional email devices but also as real-time communication devices providing voice and instant messaging capability. Once their mobile device is connected to a wireless network, people can receive incoming voice over IP telephone calls and instant messages.

People are used to cellphones automatically connecting to the cellphone network. People will expect their mobile devices to automatically connect to their desired wireless networks. What is needed is an efficient method to manage the network connect and disconnect process in a wireless enabled mobile device. This method must facilitate rapid connection when a desired network comes into range, it should require little user interaction, it should minimize scan pollution, it should not deplete the battery of the mobile device too quickly, and it should not overly expose the user to rf radiation. Once the mobile device is connected to a network, the method should idle and let the operating system, wireless chip set or other applications on the mobile device handle the network connection.

A good solution for automated connection to 802.11 networks has not been found yet because typically the user device has not been used as a communication device. The traditional scenario was an 802.11 equipped laptop which the user would set on a table and go through a manual power up and network connect sequence. Automatic wifi connection in this scenario did not add much value because the user still had to put their laptop on a desk, flip up the screen and press the power button.

The current solution for automated connection to wireless networks by mobile devices, such as PDAs, is to continuously monitor for desired networks and attempt a connection when a desired network is in range. This solution is taken from the old laptop scenario when it was assumed the user would manually activate the wireless card in the laptop only when they knew a desired network was nearby. The problem with using this solution in mobile devices is that the continuous monitoring requires scanning for networks. This scanning is typically an active process, whereby the wireless enabled mobile device issues broadcast probe requests to which nearby networks respond. Thus, when a mobile device is not in range of a desired network, the continuous scanning would unnecessarily expose the user to rf radiation. Further, this scanning causes nearby networks to respond to the probe requests, reducing network bandwidth.

A step to improving performance is taught by Krantz in US2004/0120278. “If the device has not associated to a network, the scanning engine 202 instructs the NIC 201 to scan normally (step 314)” and “The scanning engine 202 instructs the NIC 201 to scan periodically using the default scanning interval (step 314).” Krantz indicates a default scanning interval of 60 seconds in one embodiment. Coupling Krantz's scanning technique with a connection attempt methodology will provide a rapid network connection when a desired network comes into range. However, if a mobile device is stationary and out of range of a desired network, Krantz's technique will still result in wasted scanning at the fixed 60 second default scanning interval.

Ayyagari in US2002/0176366 scans for a desired network and if none is available “ . . . the system waits for a few minutes 296 before again looking for the appearance of infrastructure networks 292.” Ayyagari's technique will not provide a rapid network connection if “a few minutes” is five minutes or more. If “a few minutes” is two minutes or less, Ayyagari's technique will result in a rapid network connection at the cost of wasted scanning when the mobile device is out of range of a desired network.

A manual method is not attractive either. When a user approaches one of his or her desired networks, they do not want to have to retrieve their wireless enabled mobile device from their backpack or pocket, remove the stylus, tap on the screen a few times to activate the wireless connection sequence. Similarly, when a user leaves the range of a network, they do not want to have to retrieve their mobile device from their backpack or pocket, remove the stylus, tap on the screen a few times to deactivate the wireless connection sequence. It is even possible the user may not even know that they are in range of one of their desired networks, so they would not activate the wireless connection sequence and then they might miss a voice over ip phone call.

Alone in US2004/0110530, suggests using a movement sensor in the mobile device. When the movement sensor detects that the device has moved it signals the control program on the device that movement has occurred. The control program then powers up the wireless network interface module and instructs the wireless network interface module to scan. If a desired network is nearby, the control program directs the wireless network interface module to connect, otherwise it powers off the wireless network interface module. The main problem with this implementation is the extra monetary cost and power cost of the movement sensor. Whether you use a mercury switch or a gps module to detect movement, it is still extra cost. Also, existing PDAs cannot benefit from this implementation without being retrofitted with movement sensors.

Patent application US2001/0023446 Balogh, describes scanning for networks a user may want to connect to, but does not consider the time between connection attempts.

### SUMMARY OF THE INVENTION

It is, therefore, desirable to have a method to manage the time period between wireless network connection attempts by a wireless mobile device.

According to an aspect of my invention, I propose automatically connecting a user's mobile device to one of their desired networks when the desired network comes into range. My invention provides this capability in a more power efficient way than Ayyagari in US02/0176366 by varying the time between connection attempts. I increase the time between connection attempts when the mobile device is stationary and not connected to a network, thus reducing the user's rf exposure and reducing the power consumption of the mobile device.

According to a further aspect of my invention, there is provided a method for rapid connection to a desired network by decreasing the time between connection attempts when the mobile device is moving. Krantz in US2004/0120278 uses a fixed scan frequency when the mobile device is not associated with an access point.

A mobile device configured to carry out an embodiment of my method may incorporate a movement detection scheme using a BSSID and RSSI set point methodology. This reduces the cost of the device because an attitude change sensing device is not required. A device configured to carry out an embodiment of my method may be implemented on existing wireless mobile devices.

Further objects and advantages of my invention will become apparent from a consideration of the drawings and ensuing description.

Therefore, according to an aspect of my invention, the following method steps may be carried out: A characteristic of the mobile device is determined and a network connection attempt is made. If a network connection is not achieved, the invention waits for a period of time before trying again. The time period between connection attempts is varied according to the determined characteristic.

In a typical implementation, the characteristic of the mobile device is whether the mobile device has moved since the last connection attempt. If the mobile device has moved since the last connection attempt, the time period before the next connection attempt is decreased. If the mobile device has not moved since the last connection attempt, the time period before the next connection attempt is increased.

According to a further aspect of the invention, the method or a mobile device configured to carry out an embodiment of my method, may make a determination that a desired wireless network is nearby and bypass the step of attempting to connect to the wireless network if a desired wireless network is not nearby.

According to a further aspect of the invention, if the mobile device is out of range of any wireless networks using the protocol of interest, the time between connection attempts is increased. For instance, if the protocol of interest is 802.11 and there are no 802.11 wireless networks nearby, the time between connection attempts is increased. The method, in its various aspects, media containing instructions for carrying out the method, and a device configured to carry out the method, are also claimed. Other aspects of the invention are found in the claims.

### BRIEF DESCRIPTION OF THE DRAWINGS

There will now be described preferred embodiments of the invention with reference to the drawings by way of illustration, and without intending to limit the invention to the specific embodiment disclosed, in which:

FIG. 1 is a hardware block diagram of a mobile device configured to implement the method steps of the invention;

FIG. 2 contains screenshots from a Wifi Auto-Connect application which implements the invention on an IPAQ 4150™;

FIG. 3 is a software block diagram of a mobile device configured to implement the method steps of the invention; and

FIG. 4 is a flowchart of the connection attempt cycle.

### DETAILED DESCRIPTION OF PREFERRED EMBODIMENTS OF THE INVENTION

In this patent document, including the claims, the use of the word “comprising” does not exclude other elements being present and the use of the indefinite article preceding an element does not exclude more than one of the element being present.

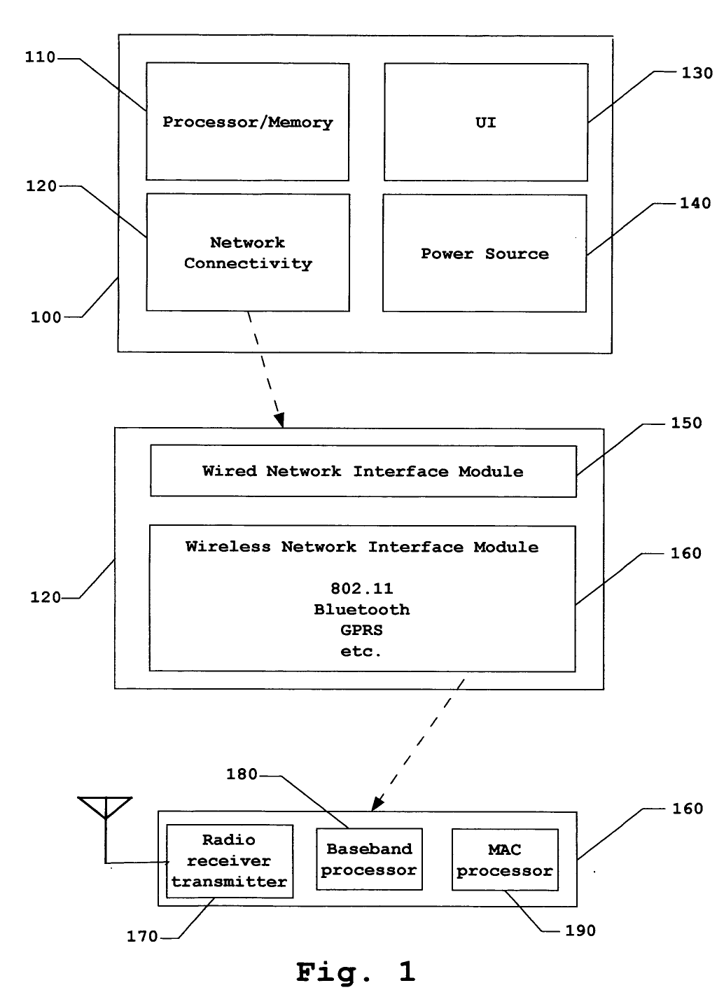

Typically, automatic connection of a mobile device to a wireless network will be implemented in a wirelessly enabled mobile device such as a PDA (personal digital assistant). The word “mobile device” includes any wireless enabled mobile device now known or hereafter developed. FIG. 1 shows the hardware block diagram of a typical mobile device 100 that is configured to implement the method steps of the automatic connection of a mobile device to a wireless network. The main subsystems of the mobile device 100 include a processor/memory block 110, a UI block 130, a power source block 140 and a network connectivity block 120. The network connectivity block 120 comprises a wired network interface module 150 and a wireless network interface module 160. The wireless network interface module 160, responds to commands from the mobile device's processor 110 and implements the wireless protocol in use by the mobile device 100. The wireless network interface module 160 comprises a radio transmitter/receiver 170, a baseband processor 180 and a MAC (media access controller) 190. If a mobile device has more than one kind of wireless it may have more than one kind of radio transmitter/receiver 170 or more than one kind of baseband processor 180 or more than one kind of MAC 190. For instance, if a mobile device 100 has 802.11 capability and Bluetooth capability it may share the radio section 170 and have 2 different MACs 190. The mobile device 100 may have GPRS capability or have capability in yet another wireless protocol. Not all of the modules and blocks mentioned are required to implement the automatic connection of a mobile device to a wireless network, they are listed here to show what is typical in a mobile device. For instance, it is not a requirement that a mobile device have a UI block 130. Also, some modules may be combined and integrated into other modules. It is conceivable that in the future the wireless network interface module 160 is integrated into the processor/memory module 110.

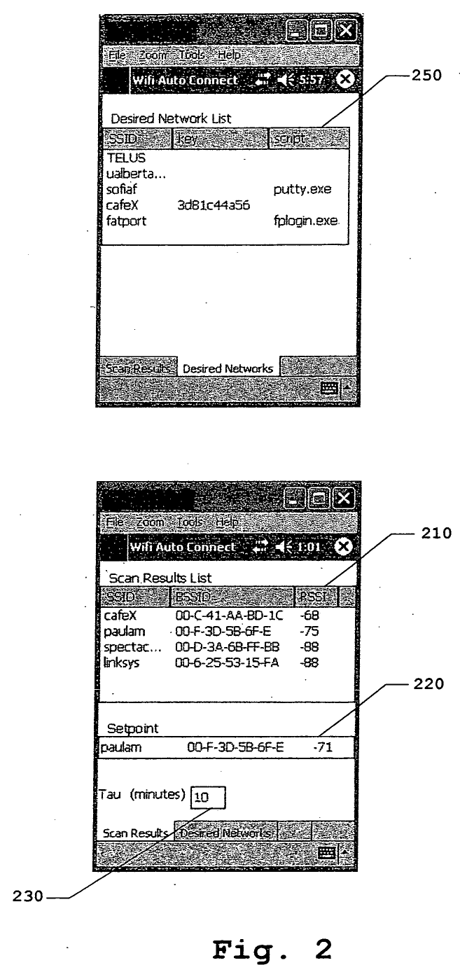

FIG. 2 shows two screen shots from a Wifi Auto-Connect application which implements an embodiment of the automatic connection of a mobile device to a wireless network. Although shown implemented as an application, the automatic connection of a mobile device to a wireless network may be implemented as part of a mobile device's operating system or as a background process on the mobile device or another way on the mobile device so as to achieve automatic wireless network connection. Not all elements illustrated in FIG. 2 are required to implement the automatic connection of a mobile device to a wireless network. Some elements can be combined and given different names. In FIG. 2, 210 is the Scan Results List. The SSID(service set identifier), BSSID(basic service set identifier or MAC address) and RSSls(receive signal strength indications) of nearby access points are recorded in 210 when a scan is performed. 220 is the Setpoint which has been selected. It includes a SSID, BSSID, and RSSI. 230 is Tau, the period in minutes of the connection attempt cycle. 250 is a Desired Network List, which is a user editable list where the user enters the SSIDs of all the wireless networks they want their mobile device to automatically connect to. In addition, the user may enter WEP keys or other connection information for each desired network. In 250, the user can also specify a login script to run when a particular network connection is made.

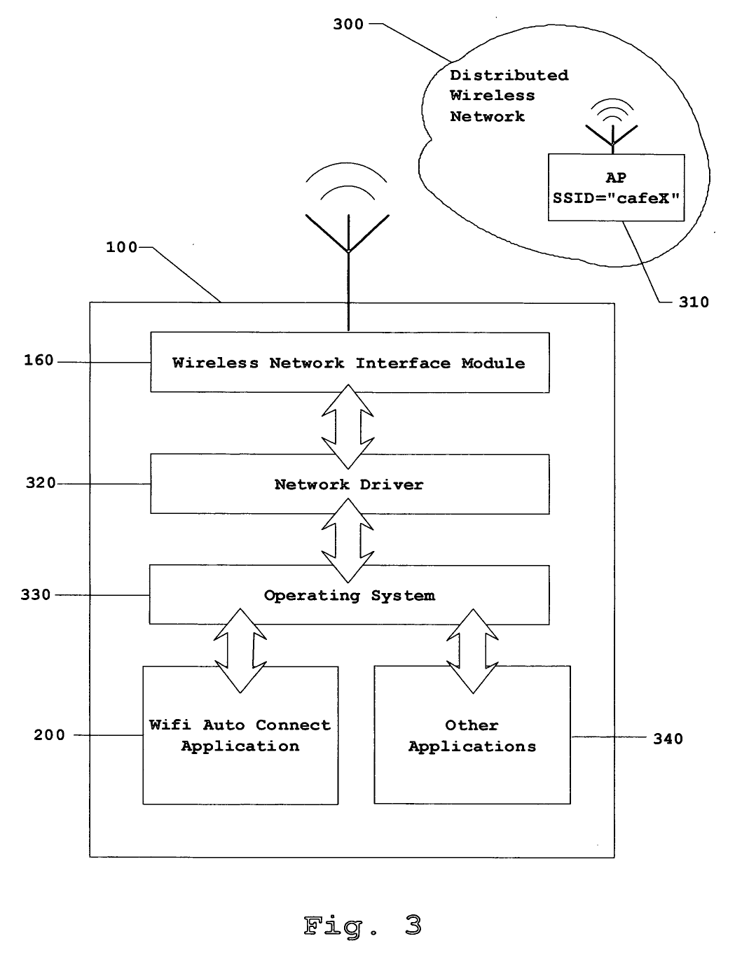

FIG. 3 shows a software block diagram of a typical mobile device 100 which implements an embodiment of the automatic connection of a mobile device to a wireless network. 320 represents the network driver for the wireless network interface module 160. 330 represents the operating system of the mobile device. 200 is the Wifi-Autoconnect application and other applications on the device are represented by block 340. Also shown is the wireless network interface module 160. 300 is the distributed wireless network which may have one or more access points, one of which is depicted by 310. Not all elements illustrated in FIG. 3 are required to implement the automatic connection of a mobile device to a wireless network. Some elements can be combined and given different names. Elements illustrated in FIG. 3 interact in a conventional manner except as required for implementation of the method and apparatus described here.

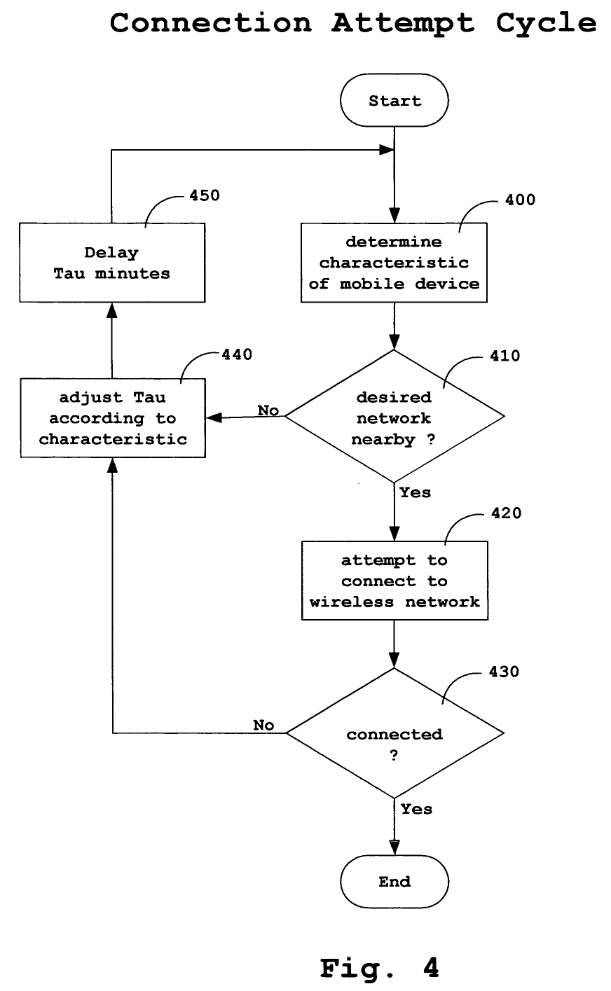

FIG. 4 is a flowchart of an embodiment of the automatic connection of a mobile device to a wireless network showing a connection attempt cycle. The exact order of the steps illustrated in FIG. 4 is not a requirement of the method of the automatic connection of a mobile device to a wireless network. Also, step 410 and step 430 are optional steps.

Step 400, “determine characteristic of mobile device”. An example of a characteristic of a mobile device 100 is a receive signal strength indication (RSSI) as received by the mobile device 100. Another example of a characteristic of a mobile device 100 is a list of scan results or other record of measurements made by the mobile device. Scanning is a way to determine these two kinds of characteristics of a mobile device. Scanning can be active or passive. An example C# language statement for scanning is:
CollectionNearbyAPs=wifiladapter.NearbyAccessPoints;
Using this C# language statement, the scan results are delivered to the collection CollectionNearbyAPs, which can then be processed to get the BSSIDs and their respective SSIDs and RSSIs to the Scan Results List 210. Another characteristic of a mobile device 100 is whether the mobile device has recently moved. Movement information can be determined using the Setpoint 220 and the Scan Results List 210. The Setpoint 220 is selected as the BSSID with the strongest RSSI. On subsequent connection attempt cycles, the RSSI of the Setpoint 220 is checked. If the RSSI of the Setpoint 220 changes beyond a threshold (for example 15 db) or if the Setpoint 220 is no longer in the Scan Results List 210, then it is determined that the mobile device 100 has moved and a new Setpoint 220 is chosen. If the Scan Results List 210 is empty, a placeholder entry is added to it. SSID=“no_networks”, BSSID=00:00:00:00:00:00, RSSI=+100 dBm. Movement information may also come from an attitude module or other motion sensing module. Another example of a characteristic of a mobile device 100 is its location. Location of the mobile device 100 may be determined by receiving information from a gps module or from a cellular telephone module, and may be as general as a determination based on a cell site footprint. Thus, the location of the mobile device may be that it is within range of a particular cell site. It is useful to have memory from connection attempt cycle to connection attempt cycle so that a characteristic of the mobile device can be the change in a parameter. For example, a characteristic of the mobile device can be the change in a RSSI or the change in a list of scan results. Other ways of determining a characteristic of a mobile device are possible.

Step 410, “desired network nearby?”. A desired network in this exemplary embodiment is a network that the mobile device is configured to connect to, either automatically or through a user prompt, a network in a list of networks stored in the mobile device or elsewhere, or any other network that the user of the mobile device prefers over other networks. In this step, it is determined if a desired network is within wireless telecommunications range of the mobile device 1 00. Determining if a desired network is nearby the mobile device 100 can be done by executing any of the network or device discovery steps of a wireless protocol. In the 802.11 protocol, issuing a scan request is a way to determine if a desired network is within wireless telecommunications range. Similarly in Bluetooth, conducting an inquiry is a way to determine if a desired network is nearby. The characteristic of the mobile device determined in step 400 can be used to determine if a desired network is nearby. The Desired Network List 250 can be compared with the Scan Results List 210 and checked for a match. Another way to implement this step is to use the location information of the mobile device 100 obtained in step 400 to look up in a database of networks to determine if a desired network is within wireless telecommunications range of the mobile device 100. Other ways to determine if a desired network is nearby the mobile device 100 are possible. If a desired network is nearby the mobile device 100, the user may be prompted by the mobile device 100 to execute a step, such as pushing a button, to complete the connection. As indicated earlier, step 410 is an optional step.

Step 420, “attempt to connect to wireless network”. In this step, the connection steps of the wireless protocol in use by the mobile device 100 are executed. In the 802.11 protocol, a station (mobile device 100) will issue a join request, then an authenticate request and then an associate request to an access point 310 of the wireless network 300 and if all goes well, then the mobile device 100 is connected to the wireless network 300. Issuing a join request or an authenticate request or an associate request is an attempt to connect to a wireless network. Most 802.11 equipped PDAs today have APIs which provide C language functions that applications can call to connect to a wireless network. An example C language function call is:
SetWLANssid(“MYNETWORK”);
By using this function call, the appropriate connection steps of the 802.11 protocol are executed (join or authenticate or associate etc.) to attempt a connection to the wireless network 300 named “MYNETWORK”. Not all mobile devices 100 will have this or similar APIs so the programmer or hardware designer may have to implement lower level functions in order to execute the connection steps of the wireless protocol in use. In the Bluetooth protocol sending a paging message or sending a paging packet is an attempt to connect to a wireless network 300. Similarly, in other wireless protocols, executing any one of the connection steps of the wireless protocol is an attempt to connect to a wireless network 300.

Step 430, labeled “connected?”, this step comprises determining if the mobile device 100 is able to receive network services from a network. A negative answer to this question can be determined if there is failed response to a connection step of the wireless protocol executed in step 420. Most 802.11 equipped PDAs today have APIs which provide functions that applications can call to query the wireless state of the mobile device 100. An example C# language statement: strConnectedAPI=wifiladapter. AssociatedAccessPoint; if the mobile device 100 is connected to a wireless network 300, the SSID of the network will be placed in the string variable strConnectedAPI. If the mobile device is not connected to a network, the statement will generate an error. Some APIs come with a specific function which when called will be true if the mobile device is connected to a network and false otherwise. Another example of how to determine if a mobile device is connected to a network is to check if the mobile device has a valid IP address. If the mobile device has a valid IP address, it is connected to a network. Another example of how to determine if a mobile device is connected to a network is to request data from a website on the internet. If valid data is received from the website, the mobile device is connected to a network. Other ways to determine if a mobile device is connected to a network are possible. As indicated earlier, step 430 is an optional step.

Step 440, labeled “adjust Tau according to characteristic”. In this step, Tau 230, is adjusted according to the characteristic of the mobile device determined in step 400. For example, if the characteristic of the mobile device determined in step 400 is that the mobile device has moved since the previous connection attempt cycle, Tau may be adjusted to a smaller value, Tau=1 minute. If the characteristic of the mobile device determined in step 400 is that the RSSI of an access point has not changed beyond a threshold, Tau may be adjusted to a larger value, Tau=20 minutes. If the characteristic of the mobile device 100 determined in step 400 is that a network in the scan results list is still in the scan results list 210, Tau may be left unchanged. Tau may have minimum and maximum values, such as 1 minute or 20 minutes. Tau may be adjusted in a non-linear manner each cycle—20 minutes, 10 minutes, 5 minutes, 2 minutes, 1 minutes if the characteristic determined in step 400 is that the mobile device has moved each cycle. Tau is normally set between 0.5 minutes and 30 minutes.

Step 450, labeled “Delay Tau minutes”. This is the idle period of the connection attempt cycle. This step may be implemented as a timer with its time interval set to Tau minutes. The power state of the mobile device may be decreased when the timer is set and then increased again when the timer expires. It would also be possible to power down the mobile device and schedule a wake up of the mobile device after Tau minutes.

The exact order of the steps of the automatic connection of a mobile device to a wireless network is not important. For instance, step 420 may precede step 400 in the cycle.

Instructions for carrying out the method steps of the automatic connection of a mobile device to a wireless network may be stored on any suitable media readable by a mobile device. The media may be any media now known or hereafter developed, including ROM or RAM of any kind, and may be conveyed to a mobile device by any suitable means.

Even though the description has examples which are 802.11 oriented, the description is not to be limited to 802.11. Mobile devices which use other wireless protocols can use the automatic connection of a mobile device to a wireless network as well.

Immaterial modifications may be made to the embodiments of the invention described here without departing from the invention.

1. A method for connecting a mobile device to a wireless network, where the mobile device is configured to execute a connection attempt cycle for connecting to a wireless network, the method comprising the steps of:
initiating a connection attempt cycle, the connection attempt cycle including plural connection attempts spaced by time periods; and
adjusting the time periods between connection attempts according to a characteristic of the mobile device.

2. The method of claim 1 in which a connection attempt comprises determining if a desired wireless network is nearby the mobile device.

3. The method of claim 2 in which the time periods between connection attempts are adjusted according to a received signal strength indication, RSSI, or a change in RSSI.

4. The method of claim 2 in which the time periods between connection attempts are adjusted based on location of the mobile device or a change of location of the mobile device.

5. The method of claim 2 in which the time periods between connection attempts are adjusted based on gps data.

6. The method of claim 2 in which the time periods between connection attempts are adjusted based on a scan result.

7. The method of claim 2 in which the time periods between connection attempts are decreased when the mobile device changes from a stationary state to a moving state.

8. The method of claim 2 in which the time periods between connection attempts are increased when the mobile device changes from a moving state to a stationary state.

9. The method of claim 2 in which the time periods between connection attempts are decreased when the mobile device has changed location between connection attempts.

10. The method of claim 2 in which determining if a desired wireless network is nearby the mobile device comprises scanning for wireless networks to produce a scan result and checking the scan result.

11. The method of claim 2 in which determining if a desired wireless network is nearby the mobile device comprises determining the location of the mobile device and using the location of the mobile device to check a database of wireless network locations.

12. The method of claim 2 in which a connection attempt comprises a prompt to a user of the mobile device to execute a step to make a connection to the desired wireless network.

13. The method of claim 1 in which the time periods between connection attempts are adjusted according to a receive signal strength indication, RSSI, or change in RSSI.

14. The method of claim 1 in which the time periods between connection attempts are adjusted based on the location of the mobile device or a change of location of the mobile device.

15. The method of claim 1 in which the time periods between connection attempts are adjusted based on gps data.

16. The method of claim 1 in which the time periods between connection attempts are adjusted based on a scan result.

17. A method of operating a mobile device, the method comprising the steps of:
a) determining a characteristic of the mobile device;
b) setting a parameter Tau according to the characteristic of the mobile device;
c) attempting to connect the mobile device to a wireless telecommunication network;
d) repeating steps a through c after a time period based on Tau.

18. The method of claim 17 wherein the step of attempting to connect the mobile device to a wireless network comprises determining if a wireless network is nearby the mobile device and if a wireless network is nearby, attempting to connect the mobile device to the wireless network.

19. The method of claim 17 wherein the step of setting a parameter Tau according to a characteristic of the mobile device comprises setting Tau to a maximum value.

20. The method of claim 17 wherein the step of setting a parameter Tau according to a characteristic of the mobile device comprises setting Tau to a minimum value.

21. A method for automatically connecting a mobile device to a wireless network, the method comprising the steps of:
determining a characteristic of the mobile device;
adjusting a delay period according to the characteristic of the mobile device;
attempting to connect the mobile device to the wireless network; and
waiting for the delay period.

22. A mobile device or media readable by a mobile device, the mobile device or media readable by a mobile device being configured to carry out the method steps of claim 1.

23. A mobile device or media readable by a mobile device, the mobile device or media readable by a mobile device being configured to carry out the method steps of claim 2.
